(19) United States
(12) Patent Application Publication
(10) Pub. No.: US 2011/0109373 A1
(43) Pub. Date: May 12, 2011

(54) TEMPERATURE COEFFICIENT MODULATING CIRCUIT AND TEMPERATURE COMPENSATION CIRCUIT

(75) Inventors: Ji-Ming Chen, Wuxi (CN); Huan-Wen Chien, Taipei County (TW)

(73) Assignee: GREEN SOLUTION TECHNOLOGY CO., LTD., Taipei County (TW)

(21) Appl. No.: 12/851,565

(22) Filed: Aug. 6, 2010

(30) Foreign Application Priority Data
Nov. 12, 2009 (CN) 200910222705.7

(51) Int. Cl. G01K 7/00

(52) U.S. Cl. 327/513

(57) ABSTRACT

In the conventional temperature compensation circuit, the thermal resistor is used to perform the temperature compensation, but the provided compensation range is limited due to the temperature coefficient of the thermal resistor. The embodiment of the invention provides a temperature coefficient modulating circuit capable of amplifying the temperature coefficient of the thermal resistor, so as to provide a wider compensation range in different applications.

### CROSS-REFERENCE TO RELATED APPLICATION

This application claims the priority benefit of China application serial no. 200910222705.7, filed on Nov. 12, 2009. The entirety of the above-mentioned patent application is hereby incorporated by reference herein and made a part of this specification.

### BACKGROUND OF THE INVENTION

1. Field of the Invention

The invention relates to a temperature coefficient modulating circuit and a temperature compensation circuit, and more particularly to a temperature coefficient modulating circuit and a temperature compensation circuit capable of enhancing the temperature coefficient.

2. Description of Related Art

The characteristic of electric device will vary with the operation temperature. In order to avoid the change of the temperature affecting the characteristic of electric device, the temperature compensation is generally used to modify the effect due to the temperature. For the temperature compensation, the popular reference device is the thermal resistor. The characteristic of thermal resistor of which the resistance changes along with the temperature is used to compensate the characteristic of electric device changing along with the temperature, so that the compensated characteristic of electric device does not change along with the temperature.

The temperature coefficient range provided by the thermal resistor is limited. Therefore, the thermal resistor can not be used to sufficiently compensate the temperature effect under the application in which a larger temperature coefficient is needed. For the situation in which the larger temperature coefficient is needed to perform the temperature compensation, the temperature compensation circuit as shown in FIG. 1 is used to enhance the temperature coefficient in the prior art. FIG. 1 is a schematic circuit diagram of a conventional temperature compensation circuit. Referring to FIG. 1, the conventional temperature compensation circuit includes a current source IDC, a thermal resistor RNTC, an analog-to-digital converter A/D, and a programmable current source IC. The current source IDC provides a stable, temperature-independent current flowing through the thermal resistor RNTC, and the thermal resistor RNTC is a resister having the negative temperature coefficient. Accordingly, when the temperature is raised, the voltage drop across the thermal resistor RNTC will fall down. The analog-to-digital converter A/D detects the change of the voltage drop across the thermal resistor RNTC, and converts it to a digital control signal to control the output current IOUT_TC of the programmable current source IC, so that the output current IOUT_TC changes along with the temperature. Through the analog-to-digital converter A/D, the change of the voltage drop across the thermal resistor RNTC is proportionally amplified as the change of the output current IOUT_TC of the programmable current source IC. Accordingly, the temperature compensation circuit has a temperature coefficient larger than the temperature coefficient of the thermal resistor.

However, by using the analog-to-digital converter A/D, the chip area of the circuit is increased, so that the cost thereof is increased, and the complexity thereof is also increased. Furthermore, the precision of the temperature coefficient is affected by that of the analog-to-digital converter A/D, too.

### SUMMARY OF THE INVENTION

Accordingly, in the prior art, the cost of the temperature compensation circuit is high, and the configuration thereof is complex. In the embodiment of the invention, one or more than one temperature coefficient modulating circuits are used to enhance the temperature coefficient, so that the temperature coefficient can be correspondingly amplified in different applications. Furthermore, the temperature coefficient modulating circuit can be achieved by a simple analog amplifier. Accordingly, the configuration of the circuit of the invention is simple, the temperature coefficient is precise, and the cost of the circuit is low.

An embodiment of the invention provides a temperature coefficient modulating circuit including a first coefficient modulating circuit, a first resistor, and a second coefficient modulating circuit. The first coefficient modulating circuit has a first temperature coefficient. The first coefficient modulating circuit receives an input signal and outputs a first current according to the input signal and the first temperature coefficient. The first resistor has a first opposite temperature coefficient, and the first resistor is coupled to the first coefficient modulating circuit to generate a first voltage according to the first current. Herein, the first opposite temperature coefficient and the first temperature coefficient have opposite signs. The second coefficient modulating circuit has a second temperature coefficient device, and the second temperature coefficient device has a second temperature coefficient. The second coefficient modulating circuit receives the first voltage and outputs a second current according to the first voltage and the second temperature coefficient. Herein, the second temperature coefficient and the first temperature coefficient have equal sign.

Another embodiment of the invention provides a temperature compensation circuit including a detecting circuit, a first resistor, and a coefficient modulating circuit. The detecting circuit has a first temperature coefficient and is coupled to a detected unit to output a first current. Herein, a temperature coefficient of the detected unit and the first temperature coefficient have equal sign. The first resistor has a first opposite temperature coefficient, and the first resistor is coupled to the detecting circuit to generate a first voltage according to the first current. Herein, the first opposite temperature coefficient and the first temperature coefficient have opposite signs. The coefficient modulating circuit has a second temperature coefficient. The coefficient modulating circuit receives the first voltage and outputs a second current according to the first voltage and the second temperature coefficient. Herein, the second temperature coefficient and the first temperature coefficient have equal sign.

It is to be understood that both the foregoing general description and the following detailed description are exemplary, and are intended to provide further explanation of the invention as claimed. In order to make the features and the advantages of the present invention comprehensible, exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit diagram of a conventional temperature compensation circuit.

FIG. 2 is a schematic circuit diagram of a temperature coefficient modulating circuit according to a first embodiment of the invention.

FIG. 3 is a schematic circuit diagram of a temperature coefficient modulating circuit according to a second embodiment of the invention.

FIG. 4 is a schematic circuit diagram of a temperature coefficient modulating circuit according to a third embodiment of the invention.

FIG. 5 is a schematic circuit diagram of a temperature coefficient modulating circuit according to a fourth embodiment of the invention.

FIG. 6 is a schematic circuit diagram of a temperature compensation circuit according to an embodiment of the invention.

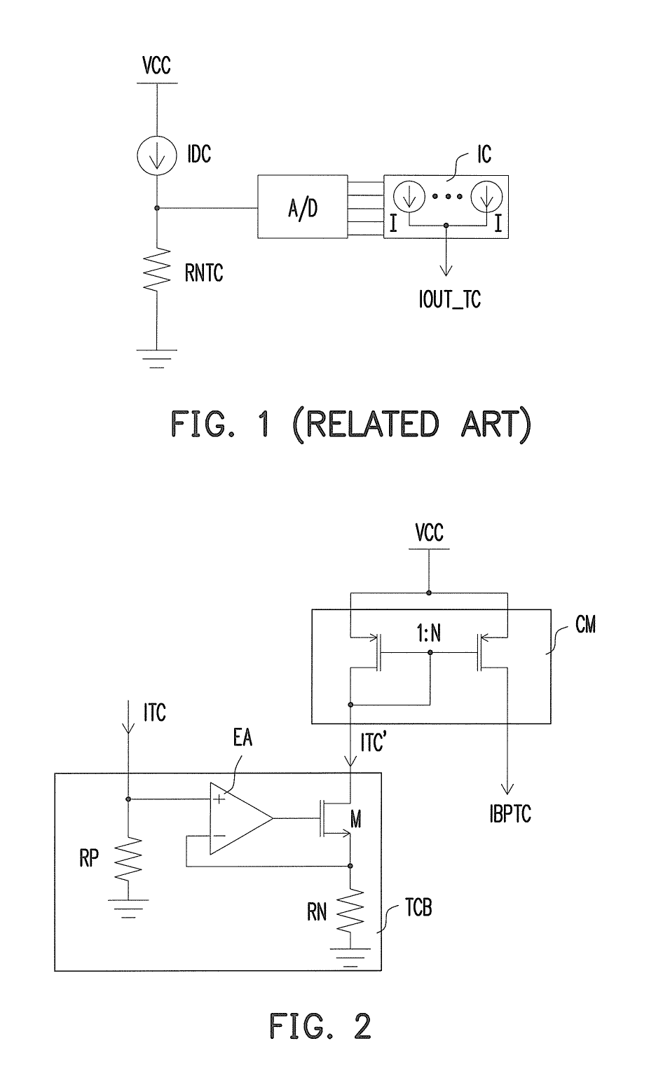

### DESCRIPTION OF EMBODIMENTS

FIG. 2 is a schematic circuit diagram of a temperature coefficient modulating circuit according to a first embodiment of the invention. Referring to FIG. 2, the temperature coefficient modulating circuit includes a coefficient modulating circuit TCB and a current minor circuit CM. The coefficient modulating circuit TCB includes a first thermal resistor RP, an amplifier EA, a transistor M, and a second thermal resistor RN, wherein the first thermal resistor RP has a positive temperature coefficient, and the second thermal resistor RN has a negative temperature coefficient. The coefficient modulating circuit TCB receives an input signal ITC, and in the present embodiment, the input signal ITC is a current signal. The current signal passes through the first thermal resistor RP to generate a voltage drop, and is inputted to the non-inverting input end of the amplifier EA. The transistor M has a first end, a second end, and a control end. The first end of the first transistor provides an amplified current ITC′, and the second end thereof is connected to the second thermal resistor RN to generate a signal to the inverting input end of the amplifier EA. The output end of the amplifier EA is connected to the control end of the transistor M. Because the amplifier EA and the transistor M form a voltage follower, the voltages of the inverting input end and the non-inverting input end of the amplifier EA are equal, thereby obtaining:

Itc*Rp=Itc′*Rn;

Herein, Itc is the amount of the input signal ITC, Itc′ is the amount of the amplified current ITC′, Rp is the resistance of the first thermal resistor RP, and Rn is the resistance of the second thermal resistor RN.

The above equation can be rewritten as I tc′=I tc*(Rp/Rn).

Accordingly, the current of the input signal ITC is proportionally amplified as the amplified current ITC′ by the ratio RP/RN. In the present embodiment, the resistance Rn of the second thermal resistor RN has a negative temperature coefficient (<1), and thus, the resistance Rn falls down along with the raise of temperature. On the contrary, the resistance Rp of the first thermal resistor RP has a positive temperature coefficient (>1), and thus, the ratio RP/RN is greater than the temperature coefficient of the resistance Rp, thereby achieving the effect of amplifying the temperature coefficient.

Because the current direction of the amplified current ITC′ is that of flowing into the coefficient modulating circuit TCB, for some applications, such as the requirement of the current direction of flowing out of the coefficient modulating circuit TCB, the current mirror circuit CM can be connected and used to provide an output current IBPTC having the current direction of flowing out of the coefficient modulating circuit TCB as the present embodiment. The width/length ratio of the channel of the two PMOSFET forming the current mirror circuit CM is 1:N, so that the amount of the provided current can be further modulated to satisfy the requirements of different currents.

The input signal ITC may be a detecting signal or a temperature-independent signal. If the input signal ITC is the detecting signal, through the temperature coefficient modulating circuit in the embodiment of the invention, the detecting signal affected by the temperature can be compensated, so that the output signal IBPTC can represent a temperature-independent detecting result. If the input signal ITC is the temperature-independent signal, the output signal IBPTC can be a signal changing along with the temperature to provide the reference of the change corresponding to the temperature for other circuits. These applications can refer to other embodiments in following.

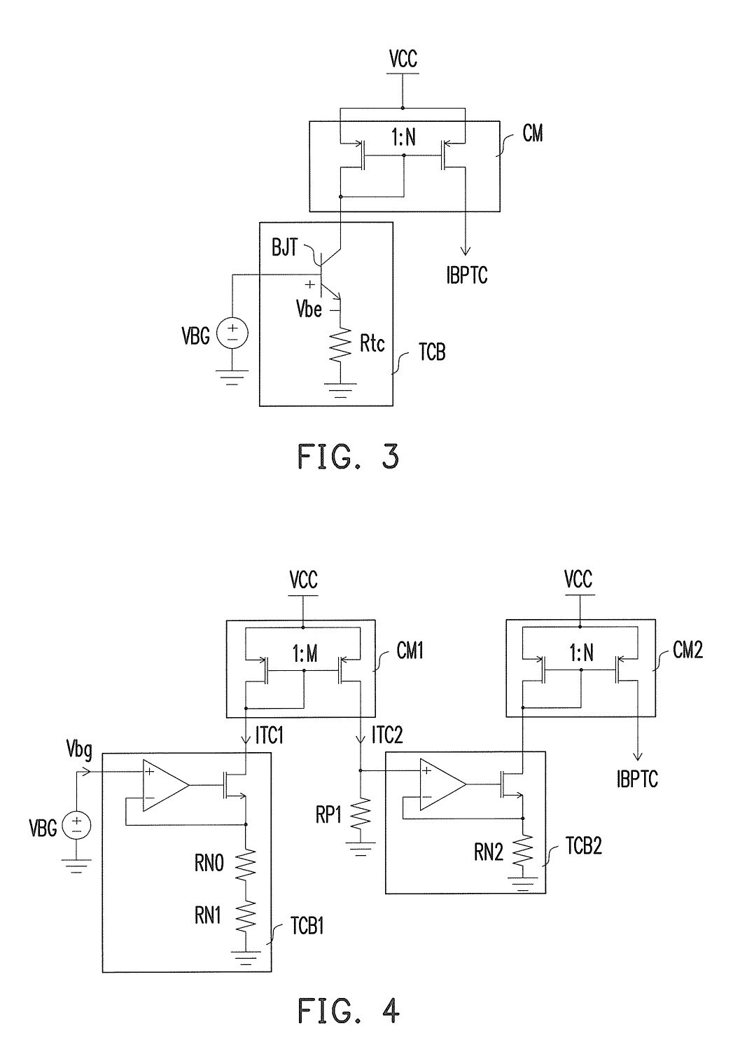

FIG. 3 is a schematic circuit diagram of a temperature coefficient modulating circuit according to a second embodiment of the invention. Referring to FIG. 3, the temperature coefficient modulating circuit includes a bandgap reference circuit VBG, a coefficient modulating circuit TCB and a current mirror circuit CM. The difference between the temperature coefficient modulating circuit of the present embodiment and that of the first embodiment lies in the coefficient modulating circuit TCB. The coefficient modulating circuit TCB includes a bipolar junction transistor BJT and a temperature coefficient device Rtc. The bandgap reference circuit VBG provides a temperature-independent voltage signal to the base of the BJT. The emitter of the BJT is coupled to the temperature coefficient device Rtc. The temperature coefficient device Rtc may be a thermal resistor having a negative temperature coefficient. The threshold voltage Vbe of the BJT has a negative temperature coefficient. Accordingly, when the temperature is raised, the voltage drop across the temperature coefficient device Rtc is also raised, so that the slope of the current raised along with the temperature (i.e. the temperature coefficient) is greater than that of the current raised along with the temperature by only the temperature coefficient device Rtc. After the current passes through the current mirror circuit CM, an output current IBPTC is generated.

FIG. 4 is a schematic circuit diagram of a temperature coefficient modulating circuit according to a third embodiment of the invention. Referring to FIG. 4, the temperature coefficient modulating circuit includes a first coefficient modulating circuit TCB1, a resistor RP1, a second coefficient modulating circuit TCB2, a first current mirror circuit CM1, and a second current mirror circuit CM2. The first coefficient modulating circuit TCB1 has a first temperature coefficient device, and in the present embodiment, the first temperature coefficient device is formed by coupling a first negative temperature coefficient thermal resistor RN0 and a second negative temperature coefficient thermal resistor RN1 in series. The first coefficient modulating circuit TCB1 includes a voltage follower formed by an amplifier and a transistor to receive an input signal Vbg generated by a bandgap reference circuit VBG, so that the voltage drop across the first temperature coefficient device is equal to the voltage of the input signal Vbg, wherein the voltage of the input signal Vbg is a temperature-independent voltage. Regarding the voltage follower, the description thereof can refer to that of FIG. 2. Accordingly, a first current ITC1 flows through the first temperature coefficient device and the transistor, and the amount of the first current ITC1 is equal to the value by dividing the voltage drop of the first temperature coefficient device with the resistance of the first temperature coefficient device, so that the first current ITC1 has a positive temperature coefficient.

The first current minor circuit CM1 is coupled between the first coefficient modulating circuit TCB1 and the resistor RP1 to amplify the first current ITC1 as an amplified current ITC2 to be provided to the resistor RP1. In the present embodiment, the temperature coefficient of the resistor RP1 and the temperature coefficient of the first temperature coefficient device in the first coefficient modulating circuit TCB1 have opposite signs. That is, if the temperature coefficient of the resistor RP1 is positive, the temperature coefficient of the first temperature coefficient device is negative. On the contrary, if the temperature coefficient of the resistor RP1 is negative, the temperature coefficient of the first temperature coefficient device is positive. In the present embodiment, the resistor RP1 has a positive temperature coefficient. Accordingly, the temperature coefficient of the voltage signal generated by the amplified current ITC2 flowing through the resistor RP1 is further enhanced. The configuration of the second coefficient modulating circuit TCB2 is similar to that of the first coefficient modulating circuit TCB1. The second coefficient modulating circuit TCB2 includes a voltage follower formed by an amplifier and a transistor and a second temperature coefficient device RN2. In the present embodiment, the second temperature coefficient device RN2 is a thermal resister RN2 having a negative temperature coefficient, and the temperature coefficient of the second temperature coefficient device RN2 and that of the first temperature coefficient device have equal sign. Accordingly, the temperature coefficient of the voltage signal generated by the resister RP1 is enhanced again, and after amplified by the second current mirror circuit CM2, an output current IBPTC is generated.

Compared with that of the foregoing two embodiments, the temperature coefficient modulating circuit of the third embodiment shown in FIG. 4 further includes the resistor RP1 and the second coefficient modulating circuit TCB2 for performing the enhancement of the temperature coefficient. Accordingly, the enhancement of the temperature coefficient is more obvious in the present embodiment.

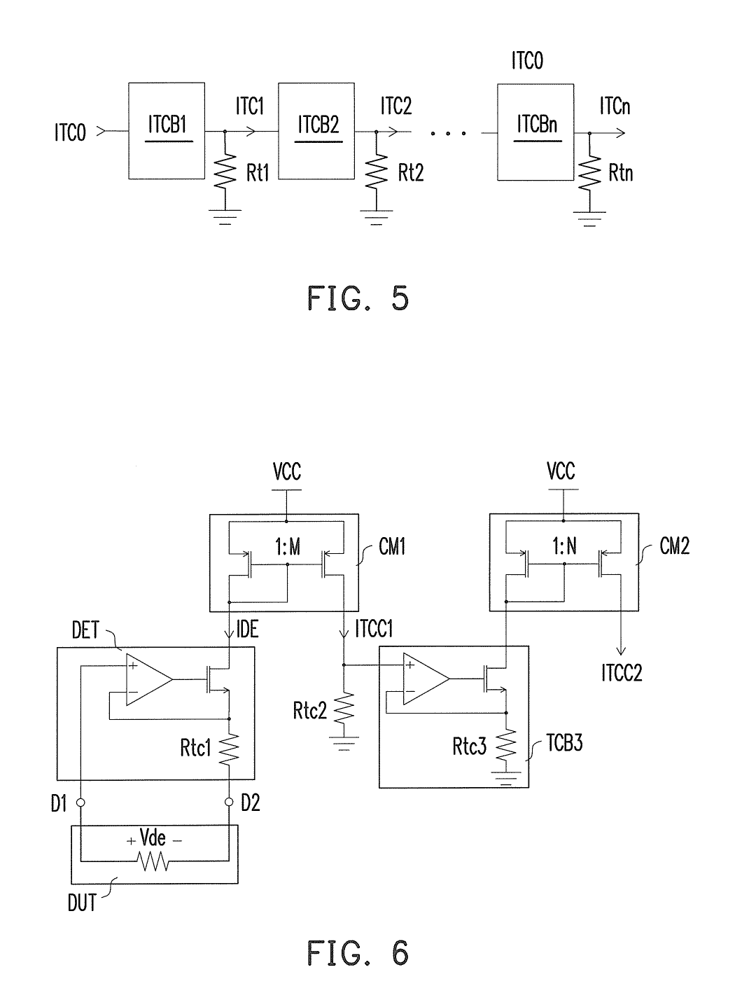

FIG. 5 is a schematic circuit diagram of a temperature coefficient modulating circuit according to a fourth embodiment of the invention. Referring to FIG. 5, the input signal ITC0 becomes the output signal ITCn after being amplified stage by stage through the first coefficient modulating circuit ITCB1, the first resistor Rt1, the second coefficient modulating circuit ITCB2, the second resistor Rt2, . . . , the n^{th} coefficient modulating circuit ITCBn, and the n^{th} resistor Rtn. The coefficient modulating circuits ITCB1, ITCB2, . . . , and ITCBn can be implemented by the coefficient modulating circuit in the foregoing embodiments, and the temperature coefficient modulating amount of each coefficient modulating circuit (i.e. the output signal/the received signal) has equal sign. Furthermore, whether the first resistor Rt1, the second resistor Rt2, and the n^{th} resistor Rtn are used can be determined according to the signal to be outputted being a voltage or a current, or the type of the signal which can be processed by next stage circuit. As shown in FIGS. 2-4, the input of the coefficient modulating circuit is a voltage signal, and the output of the coefficient modulating circuit is a current signal. Accordingly, through the resistors Rt1-Rtn, the outputted current signal is converted to a voltage signal.

FIG. 6 is a schematic circuit diagram of a temperature compensation circuit according to an embodiment of the invention. Referring to FIG. 6, the temperature compensation circuit includes a detecting circuit DET, a resistor Rtc2, and a coefficient modulating circuit TCB3. The detecting circuit DET has a first temperature coefficient device Rtc1, and through a first detecting end D1 and a second detecting end D2, the detecting circuit DET is coupled to a detected unit DUT to output a first current IDE. In the present embodiment, the first detecting end D1 and the second detecting end D2 are two input ends of the amplifier in the detecting circuit DET. In order to compensate the change of the voltage drop Vde of the detected unit DUT along with the temperature, the temperature coefficient of the first temperature coefficient device Rtc1 and that of the detected unit DUT have equal sign, but the temperature coefficient of the first temperature coefficient device Rtc1 and that of the resistor Rtc2 have opposite signs. The first current IDE is amplified as the current ITCC1 through the first current mirror circuit CM1, and the current ITCC1 is inputted to the resistor Rtc2 to generate a voltage signal to be inputted to the coefficient modulating circuit TCB3. The coefficient modulating circuit TCB3 has a temperature coefficient which has an equal sign with the first temperature coefficient device Rtc1. The coefficient modulating circuit TCB3 outputs the current according to the voltage signal and the temperature coefficient thereof, and the current is amplified as the current ITCC2 to be outputted through a second current mirror circuit CM2.

The detected unit DUT may be a detecting resistor (e.g. the feedback detecting resistor used in the feedback control circuit), an on-resistance of a MOSFET, an LED, or other electric devices, even circuits of which the characteristics change along with the temperature. The equivalent temperature coefficient of the temperature compensation circuit in the present embodiment can be changed by modulating the temperature coefficients of the coefficient modulating circuit and the thermal resistor, so as to be just the reciprocal of the temperature coefficient of the detected unit DUT. Accordingly, an output signal of the temperature compensation circuit is temperature-independent.

To sum up, the temperature coefficient modulation in the embodiment of the invention is achieved through simple analog circuits and devices, such as the amplifier, the thermal resister, and the transistor. Accordingly, the configuration of the circuit is quite simple, and the cost thereof is quite low. Furthermore, the number or the temperature coefficient of the coefficient modulating circuit can be correspondingly modulated to obtain the temperature compensation satisfying the requirement in different applications.

As the above description, the invention completely complies with the patentability requirements: novelty, non-obviousness, and utility. It will be apparent to those skilled in the art that various modifications and variations can be made to the structure of the present invention without departing from the scope or spirit of the invention. In view of the foregoing descriptions, it is intended that the present invention covers modifications, and variations of this invention if they fall within the scope of the following claims and their equivalents.

What is claimed is:

1. A temperature coefficient modulating circuit, comprising:
a first coefficient modulating circuit having a first temperature coefficient, and the first coefficient modulating circuit receiving an input signal and outputting a first current according to the input signal and the first temperature coefficient;
a first resistor having a first opposite temperature coefficient, and the first resistor coupled to the first coefficient modulating circuit to generate a first voltage according to the first current, wherein the first opposite temperature coefficient and the first temperature coefficient have opposite signs; and
a second coefficient modulating circuit having a second temperature coefficient device, the second temperature coefficient device having a second temperature coefficient, and the second coefficient modulating circuit receiving the first voltage and outputting a second current according to the first voltage and the second temperature coefficient, wherein the second temperature coefficient and the first temperature coefficient have equal sign.

2. The temperature coefficient modulating circuit as claimed in claim 1, wherein the first coefficient modulating circuit comprises:
a first amplifier having a first input end, a second input end, and a first output end, and the first input end receiving the input signal;
a first transistor having a first end, a second end, and a first control end, and the first transistor providing the first current; and
a first temperature coefficient device having a first temperature coefficient resistor, and the first temperature coefficient resistor coupled to the second end of the first transistor to generate a first temperature coefficient modulating signal to the second input end of the first amplifier according to the first current;
wherein the first amplifier outputs a first control signal to the first control end of the first transistor to modulate the first current according to the input signal and the first temperature coefficient modulating signal.

3. The temperature coefficient modulating circuit as claimed in claim 1, further comprising a first current mirror circuit, wherein the first current mirror circuit is coupled between the first coefficient modulating circuit and the first resistor, and the first current mirror circuit amplifies the first current to be provided to the first resistor.

4. The temperature coefficient modulating circuit as claimed in claim 1, further comprising:
a second resistor having a second opposite temperature coefficient, and the second resistor coupled to the second coefficient modulating circuit to generate a second voltage according to the second current, wherein the second opposite temperature coefficient and the second temperature coefficient have opposite signs; and
a third coefficient modulating circuit having a third temperature coefficient device, the third temperature coefficient device having a third temperature coefficient, and the third coefficient modulating circuit receiving the second voltage and outputting a third current according to the second voltage and the third temperature coefficient, wherein the third temperature coefficient and the second temperature coefficient have equal sign.

5. The temperature coefficient modulating circuit as claimed in claim 4, further comprising a second current mirror circuit, wherein the second current mirror circuit is coupled between the second coefficient modulating circuit and the second resistor to amplify the second current as a second amplified current.

6. The temperature coefficient modulating circuit as claimed in claim 3, wherein the second coefficient modulating circuit comprises:
a second amplifier having a third input end, a fourth input end, and a second output end, and the third input end receiving the first voltage;
a second transistor having a third end, a fourth end, and a second control end, and the second transistor providing the second current; and
the second temperature coefficient device having a second temperature coefficient resistor, and the second temperature coefficient resistor coupled to the fourth end of the second transistor to generate a second temperature coefficient modulating signal to the fourth input end of the second amplifier according to the second current;
wherein the second amplifier outputs a second control signal to the second control end of the second transistor to modulate the second current according to the first voltage and the second temperature coefficient modulating signal.

7. The temperature coefficient modulating circuit as claimed in claim 1, wherein the first coefficient modulating circuit comprises:
a bipolar junction transistor having a base, an emitter, and a collector, the base receiving the input signal, and the collector providing the first current; and
a first temperature coefficient device coupled to the emitter of the bipolar junction transistor.

8. A temperature compensation circuit, comprising:
a detecting circuit having a first temperature coefficient and coupled to a detected unit to output a first current, wherein a temperature coefficient of the detected unit and the first temperature coefficient have equal sign;
a first resistor having a first opposite temperature coefficient, and the first resistor coupled to the detecting circuit to generate a first voltage according to the first current, wherein the first opposite temperature coefficient and the first temperature coefficient have opposite signs; and
a coefficient modulating circuit having a second temperature coefficient, and the coefficient modulating circuit receiving the first voltage and outputting a second current according to the first voltage and the second temperature coefficient, wherein the second temperature coefficient and the first temperature coefficient have equal sign.

9. The temperature compensation circuit as claimed in claim 8, wherein the detecting circuit comprises:
a first amplifier having a first input end, a second input end, and a first output end, and the first input end coupled to one end of the detected unit;
a first transistor having a first end, a second end, and a first control end, and the first transistor providing the first current; and
a first temperature coefficient device coupled to the second end of the first transistor and the other end of the detected unit to generate a first temperature coefficient modulating signal into the second input end of the first amplifier according to the first current.

10. The temperature compensation circuit as claimed in claim 8, further comprising a first current mirror circuit, wherein the first current mirror circuit is coupled between the detecting circuit and the first resistor, and the first current mirror circuit amplifies the first current to be provided to the first resistor.

11. The temperature compensation circuit as claimed in claim 10, further comprising a second resistor, wherein the second resistor has a second opposite temperature coefficient, and the second resistor is coupled to the coefficient modulating circuit to generate a second voltage according to the second current, wherein the second opposite temperature coefficient and the second temperature coefficient have opposite signs.

12. The temperature compensation circuit as claimed in claim 11, further comprising a second current mirror circuit, wherein the second current mirror circuit is coupled between the coefficient modulating circuit and the second resistor to amplify the second current as a second amplified current.

13. The temperature compensation circuit as claimed in claim 10, wherein the coefficient modulating circuit comprises:
a second amplifier having a third input end, a fourth input end, and a second output end, and the third input end receiving the first voltage;
a second transistor having a third end, a fourth end, and a second control end, and the second transistor providing the second current; and
the second temperature coefficient device having a second temperature coefficient resistor, and the second temperature coefficient resistor coupled to the fourth end of the second transistor to generate a second temperature coefficient modulating signal to the fourth input end of the second amplifier according to the second current;
wherein the second amplifier outputs a second control signal to the second control end of the second transistor to modulate the second current according to the first voltage and the second temperature coefficient modulating signal.

14. The temperature compensation circuit as claimed in claim 8, wherein the detecting circuit comprises:
a bipolar junction transistor having a base, an emitter, and a collector, the base coupled to one end of the detected unit, and the collector providing the first current; and
a first temperature coefficient device coupled to the emitter of the bipolar junction transistor and the other end of the detected unit.
